(19) United States
(12) Patent Application Publication
(10) Pub. No.: US 2012/0019461 A1
(43) Pub. Date: Jan. 26, 2012

(54) TOUCH DISPLAY DEVICE

(75) Inventors: Hui-Hua CHANG, Chu-Nan (TW); Yu-Chun TSENG, Chu-Nan (TW); Shu-Hui HSIAO, Chu-Nan (TW)

(73) Assignee: CHIMEI INNOLUX CORPORATION, Chu-Nan (TW)

(21) Appl. No.: 13/111,893

(22) Filed: May 19, 2011

(30) Foreign Application Priority Data
Jul. 22, 2010 (TW) 099124140

(51) Int. Cl. G06F 3/041

(52) U.S. Cl. 345/173

(57) ABSTRACT

The present invention provides a touch display device, which includes a display module and a touch panel. The display module includes a display panel and a control chip disposed on the display module to control the display module. The touch panel has a glass substrate and a driving chip disposed on the glass substrate to control at least one touching operation for the touch panel. The driving chip and the control chip are disposed in a misaligned manner.

### CROSS REFERENCE TO RELATED APPLICATIONS

This Application claims priority of Taiwan Patent Application No. 99124140, filed on Jul. 22, 2010, the entirety of which is incorporated by reference herein.

### BACKGROUND OF THE INVENTION

1. Field of the Invention

The present invention generally relates to a touch display device, and more particularly to a design of disposing a frame between a touch panel and a display module of the touch display device, so as to increase a structural strength of the touch display device and prevent chips and electrical connections from being subject to electromagnetic interference or damage.

2. Description of the Related Art

With progress of electronic technology, demands are increasing day by day for a touch display device in an electronic apparatus, such as a mobile phone, a digital camera, a Personal Digital Assistant (PDA), a notebook, a desktop computer, a Global Positioning System (GPS), a vehicle display, an aeronautical display, a portable DVD player, and so on.

Generally speaking, the touch display device comprises a touch panel, a display panel, a backlight module, a control chip, a driving chip, and at least one printed circuit board. Electromagnetic fields which are generated by currents will interfere with one another when the above-mentioned components of the touch display device are in operation. Furthermore, in processes of assembling the touch display device, the above-mentioned components of the touch display device are easily disconnected or chips on the touch display device can be damaged, so that the reliability of the electronic apparatus comprising such touch display device is affected. Therefore, there is a need to provide an improved structure for the touch display device to prevent the noise or electromagnetic interference and to increase a structural strength of the touch display device.

### BRIEF SUMMARY OF THE INVENTION

An objective of the present invention is to provide a touch display device. The touch display device comprises a display module and a touch panel. The display module comprises a display panel. The display module further comprises a control chip which is disposed at a bottom substrate of the display panel for controlling the display module. The touch panel comprises a substrate and a driving chip. The driving chip is disposed at the substrate for controlling at least one touching operation for the touch panel. The driving chip is disposed on one surface of the touch panel, and the control chip is disposed on one surface of the display module. The one surface of the touch panel faces the one surface of the display module. The driving chip is misaligned with the control chip.

According to an aspect of the present invention, a frame can be disposed between the touch panel and the display module to improve a structure of the touch display device, so as to increase a structural strength of the touch display device and prevent chips and electrical connections from being subject to electromagnetic interference or damage.

### BRIEF DESCRIPTION OF THE DRAWINGS

FIG. 1A illustrates a top view of a touch display device according to a first embodiment of the present invention;

FIG. 1B illustrates a section A-A′ view of the touch display device 10 in FIG. 1A;

FIG. 2A illustrates a top view of a touch display device according to a second embodiment;

FIG. 2B illustrates a section A-A′ view of the touch display device 11 in FIG. 2A;

FIG. 3A illustrates a top view of a touch display device according to a third embodiment of the present invention;

FIG. 3B illustrates a section A-A′ view of the touch display device 12 in FIG. 3A;

FIG. 3C illustrates a section B-B′ view of the touch display device 12 in FIG. 3A;

FIG. 4A illustrates a top view of a touch display panel according to a fourth embodiment of the present invention;

FIG. 4B illustrates a section A-A′ view of the touch display device 13 in FIG. 4A;

FIG. 4C illustrates a section B-B′ view of the touch display device 13 in FIG. 4A;

FIG. 5A illustrates a top view of a touch display panel according to a fifth embodiment of the present invention;

FIG. 5B illustrates a section A-A′ view of the touch display device 14 in FIG. 5A; and

FIG. 5C illustrates a section B-B′ view of the touch display device 14 in FIG. 5A.

### DETAILED DESCRIPTION OF THE INVENTION

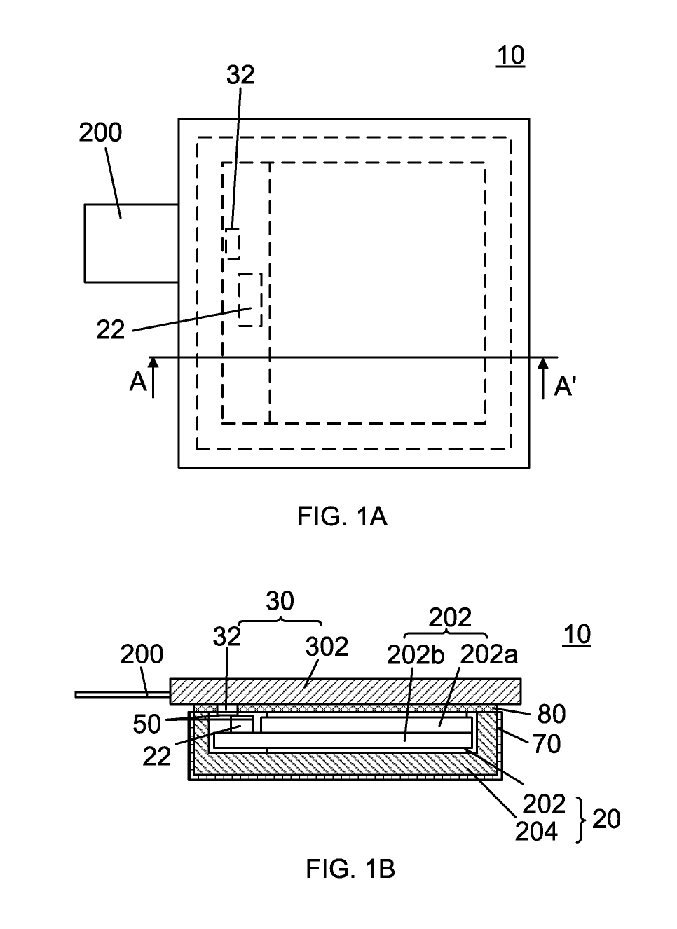

FIG. 1A illustrates a top view of a touch display device 10 according to a first embodiment of the present invention. FIG. 1B illustrates a section A-A′ view of the touch display device 10 in FIG. 1A. In FIG. 1B, the touch display device 10 comprises a display module 20 and a touch panel 30. The display module 20 can be a liquid crystal display module or other types of flat display modules. The touch panel 30 is disposed on the display module 20. The touch panel 30 comprises a substrate 302 and a driving chip 32 which is disposed on the substrate 302. The substrate 302 can be a glass substrate or other types of transparent substrates. The driving chip 32 of the touch panel 30 is misaligned with a control chip 22 of the display module 20.

A structure of the touch display device 10 can be adjusted according to different design demands. The touch display device 10 can be a backlight type liquid crystal display device in the following embodiments of the present invention. Please refer to FIG. 1B, the display module 20 is contained in a frame 70. The display module 20 comprises a display panel 202, a backlight module 204, and the control chip 22. The display panel 202, such as a liquid crystal panel, is disposed on the backlight module 204. The display panel 202 comprises a top substrate member 202a and a bottom substrate member 202b. The control chip 22 is disposed at the bottom substrate member 202b of the display panel 202. The touch panel 30 comprises the substrate 302 and the driving chip 32. The driving chip 32 is disposed on one surface of the substrate 302 for controlling at least one touching operation from a touching object (not shown) for the touch panel 30, and the one surface of the substrate 302 faces the display panel 202. The driving chip 32 faces the control chip 22 and is misaligned with the control chip 22. The touch display device 10 further comprises a flexible printed circuit board (FPCB) to electrically couple the touch panel 30 with an external circuit.

A method of disposing the driving chip 32 on the substrate 302 comprises steps below. Firstly, a patterned circuit (not shown) is formed on the substrate 302. Secondly, the driving chip 32 is flip-flop bonded on the substrate 302 through a chip-on-glass (COG) process and electrically coupled to the patterned circuit (not shown) on the substrate 302. Accordingly, a size of the touch panel 30 is not limited, and electrical connections near peripheral areas of the touch panel 30 will not be disconnected due to an external force in the proceeding assembling processes. As a result, the reliability of the touch display device 10 is increased.

As shown in FIG. 1B, the display module 20 is assembled with the touch panel 30. As mentioned above, the surface, on which the driving chip 32 is disposed, of the substrate 302 of the touch panel 30, faces the display panel 202, and the driving chip 32 of the touch panel 30 is misaligned with the control chip 22 of the display module 20, whereby prevents the control chip 22 from being too close to the driving chip 32 or prevents the control chip 22 from contacting the driving chip 32. As a result, the electromagnetic interference or noise in the operational processes of the touch display device 10 can be avoided, and thus the reliability of the touch display device 10 can be increased.

The touch panel 30 is adhered to the display module 20 by an adhesion layer 80. To prevent the reliability from being affected by the noise or the electromagnetic interference between the control chip 22 and the driving chip 32, an insulating tape 50 can be adhered to one surface of the control chip 22 and one surface of the driving chip 32, respectively.

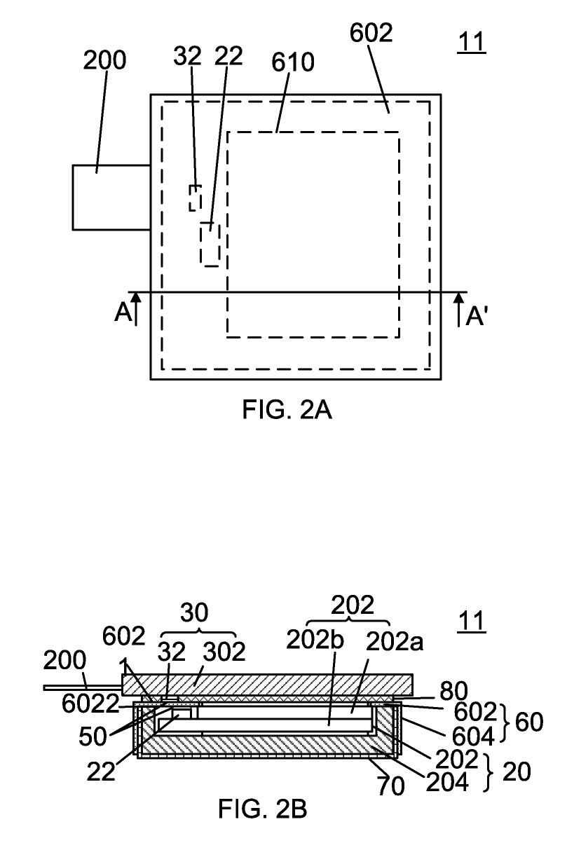

To increase the reliability and the structural strength of the touch display device 10, another frame 60 is disposed between the touch panel 30 and the display module 20 in a second embodiment, as shown in FIGS. 2A-2B. For the purpose to easily distinguish, the frame 60 is called a first frame, and the frame 70 is called a second frame in the following descriptions. The first frame 60 can prevent the reliability of the touch display device from being affected by the noise or the electromagnetic interference between the control chip 22 and the driving chip 32.

Please refer to FIGS. 2A-2B. FIG. 2A illustrates a top view of a touch display device 11 according to a second embodiment of the present invention. FIG. 2B illustrates a section A-A′ view of the touch display device 11 in FIG. 2A. As shown in FIG. 2B, the touch display device 11 comprises the display module 20, the touch panel 30, the first frame 60, and the second frame 70. The display module 20 is contained in the second frame 70. The touch panel 30 is disposed on and assembled with the display module 20 through the adhesion layer 80. The first frame 60 is disposed between the edge areas of the touch panel 30 and the display module 20. The first frame 60 has a top opening for exposing a display area of the display panel 202. A reference numeral 610 in FIG. 2A represents the top opening defined by a top frame member 602 of the first frame 60. As shown in FIG. 2B, the touch panel 30 comprises the substrate 302 and the driving chip 32 which is disposed at the substrate 302. The driving chip 32 of the touch panel 30 faces and is misaligned with the control chip 22 of the display module 20.

The first frame 60 which is disposed between the display module 20 and the touch panel 30 comprises the top frame member 602 and an edge frame member 604. The top frame member 602 is disposed between the edge areas of the touch panel 30 and the display module 20, and the top frame member 602 defines the top opening 610. The edge frame member 604 of the first frame surrounds the side edges of the display module 20. The touch panel 30 is fixed with the top frame member 602 of the first frame 60 through the adhesion layer 80. Furthermore, in the present embodiment, the display module 20 is contained in the second frame 70, whereby the display module 20 can be fixed by the first frame 60 together with the second frame 70.

In the present embodiment, the adhesion layer 80 can only be formed on peripheral edges of the surface of the touch panel 30, on which the driving chip 32 (not shown) is disposed. As a result, the top frame 602 of the first frame 60 can be adhered to the peripheral edges of the surface of the touch panel 30 through the adhesion layer 80, and displayed images of the display area of the display module 20 are not affected by the adhesion layer 80. The adhesion layer 80 can be made of a rim sheet or a tape. Furthermore, when the adhesion layer 80 is formed by coating on an entire surface of the touch panel 30, on which the driving chip 32 is disposed, the peripheral edges of the touch panel 30 can be adhered to the top frame 602 of the first frame 60 through the adhesion layer 80. In such case, the adhesion layer 80 coated on the surface of the touch panel 30 is transparent, and thus the displayed images of the display area of the display module 20 are not affected. The adhesion layer 80 can be made of an optically clear adhesive (OCA) or an optically clear resin (OCR).

In the present embodiment, a thickness of the control chip 22 is less than a thickness of the top substrate member 202a of the display panel 202, and a thickness of the driving chip 32 is less than a thickness of the adhesion layer 80 formed on the touch panel 30. The top frame member 602 of the first frame 60 shelters both the control chip 22 and the driving chip 32, but the top frame member 602 of the first frame 60 does not directly contact the surfaces of both the control chip 22 and the driving chip 32 so as to keep a structural integrity of the touch display device 11. Furthermore, in the present embodiment, an insulating tape 50 can be adhered to the surface of the driving chip 32, and the driving chip 32 can avoid to contact the top surface 6021 of the top frame member 602 of the first frame 60. Also, the insulating tape 50 cab be adhered to the surface of the control chip 22, and the control chip 22 can avoid to contact the bottom surface 6022 of the top frame member 602 of the first frame 60. Furthermore, in the present embodiment, a buffer layer (not shown), such as a sponge layer or an elastic insulating material layer, can be selectively disposed between the top frame member 602 of the first frame 60 and the edge area of the display module 20, or disposed between the top frame member 602 of the first frame 60 and the edge area of the touch panel 30, so as to increase the structural strength of the touch panel 30 of the touch display device 11 in encountering an external force, such as a touching object (not shown), on the touch display device 11.

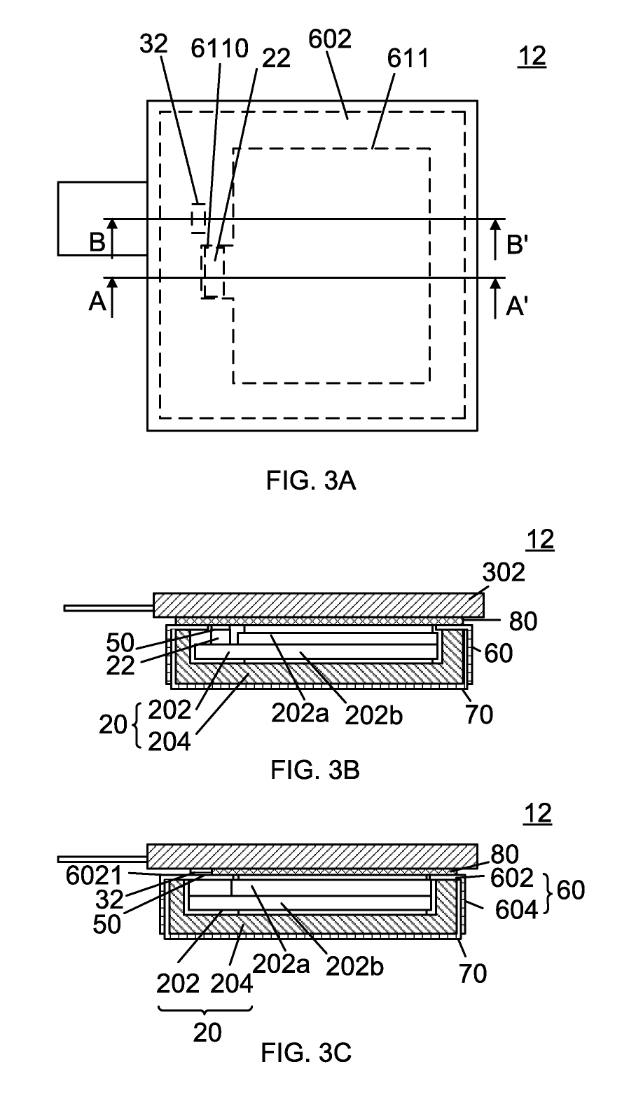

Please refer to FIGS. 3A-3C. FIG. 3A illustrates a top view of a touch display device 12 according to a third embodiment of the present invention. FIG. 3B illustrates a section A-A′ view of the touch display device 12 in FIG. 3A. FIG. 3C illustrates a section B-B′ view of the touch display device 12 in FIG. 3A. In the present embodiment, the display panel 202 and the backlight module 204 of the display module 20, the touch panel 30, the control chip 22, and the driving chip 32 have the same functions and connections as those in FIGS. 2A-2B, and thus are not repeated herein. A difference between the second embodiment and the present embodiment is that the thickness of the control chip 22 is greater than the thickness of the top substrate member 202a of the display panel 202 in the present embodiment.

The top frame member 602 of the first frame 60 does not shelter the display area of the display module 20 and the control chip 22, but the top frame member 602 of the first frame 60 does shelter the driving chip 32. Compared with the top opening 610 as shown in FIG. 2A, a top opening 611 defined by the top frame member 602 of the first frame 60 further comprises an indentation 6110 as shown in FIG. 3A for exposing the control chip 22.

As mentioned above, the difference between the second embodiment and the present embodiment is that the thickness of the control chip 22 is greater than the thickness of the top substrate member 202a of the display panel 202 in the present embodiment. That is, the control chip 22 protrudes above the display panel 202. The thickness of the driving chip 32 is less than the thickness of the adhesion layer 80. The top frame member 602 of the first frame 60 which is disposed between the display module 20 and the touch panel 30 only shelters the driving chip 32 (as shown in FIG. 3C) and exposes the control chip 22 (as shown in FIG. 3B). Accordingly, although the control chip 22 protrudes above the display panel 202 of the display module 20, the control chip 22 does not directly contact the top frame member 602 of the first frame 60 which is disposed between the display module 20 and the touch panel 30 so as to retain the structural integrity of the touch display device 12.

As shown in FIG. 3B of the present embodiment, the insulating tape 50 can be selectively disposed on the surface of the control chip 22, and the insulating tape 50 is adhered to and fixed on the adhesion layer 80, so as to increase the structural strength of the touch display device 12. Furthermore, as shown in FIG. 3C, the insulating tape 50 can be disposed on the surface of the driving chip 32, and the insulating tape 50 is adhered to and fixed on the top surface 6021 of the top frame member 602 of the first frame 60.

The same as the afore-mentioned embodiments, the touch display device 12 of the present embodiment further comprises the second frame 70 which is disposed underneath the display module 20 for containing the display module 20. As a result, the display module 20 can be fixed by the first frame 60 together with the second frame 70.

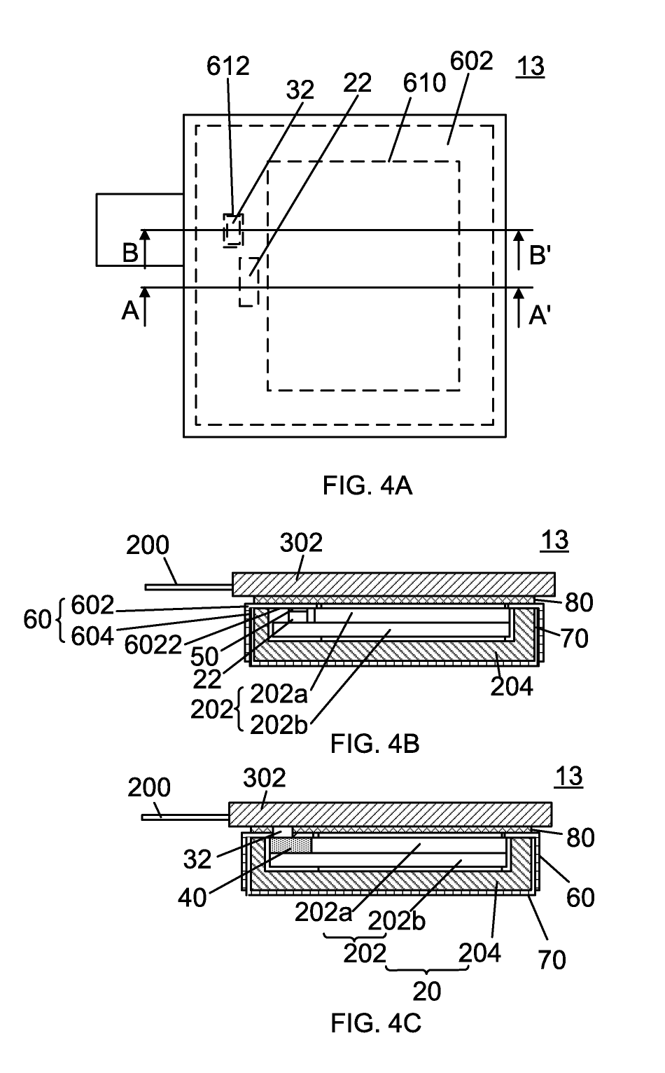

Please refer to FIGS. 4A-4C. FIG. 4A illustrates a top view of a touch display panel 13 according to a fourth embodiment of the present invention. FIG. 4B illustrates a section A-A′ view of the touch display device 13 in FIG. 4A. FIG. 4C illustrates a section B-B′ view of the touch display device 13 in FIG. 4A. In the present embodiment, the display module 20, the touch panel 30, the control chip 22, and the driving chip 32 have the same functions and connections as those in the second embodiment in FIGS. 2A and 2B, and thus are not repeated herein. Differences between the second embodiment and the present embodiment are that in the present embodiment, the thickness of the control chip 22 is less than the thickness of the top substrate member 202a of the display panel 202, and the thickness of the driving chip 32 is greater than the thickness of the adhesion layer 80.

As shown in FIG. 4A, the top opening 610 exposes the display area of the display panel 202, and the first frame 60 shelters the control chip 22 but does not shelter the driving chip 32. The top frame member 602 of the first frame 60 defines not only the top opening 610 but also another opening 612 for exposing the driving chip 32.

As mentioned above, the differences between the second embodiment and the present embodiment are that in the present embodiment, the thickness of the control chip 22 is less than the thickness of the top substrate member 202a of the display panel 202, and the thickness of the driving chip 32 is greater than the thickness of the adhesion layer 80. The top frame member 602 of the first frame 60 which is disposed between the display module 20 and the touch panel 30 shelters the control chip 22 (as shown in FIG. 4B) and exposes the driving chip 32 (as shown in FIG. 4C). Accordingly, although the thickness of the driving chip 32 is greater than the thickness of the adhesion layer 80, the driving chip 32 does not directly contact the top frame member 602 of the first frame 60 which is disposed between the display module 20 and the touch panel 30 so as to retain the structural integrity of the touch display device 13.

As shown in FIG. 4B of the present embodiment, the insulating tape 50 can be disposed on the surface of the control chip 22, and the insulating tape 50 is adhered to and fixed on the bottom surface 6022 of the top frame member 602 of the first frame 60. Furthermore, as shown in FIG. 4C, a buffer layer 40, such as a sponge layer or an elastic insulating material layer, can be selectively disposed between the exposed surface of the driving chip 32 and the display module 20, so as to increase the structural strength of the touch display device 13.

Furthermore, the display module 20 of the present embodiment is contained in the second frame 70 as mentioned in the above-mentioned embodiments. Accordingly, the display module 20 can be fixed by the first frame 60 together with the second frame 70.

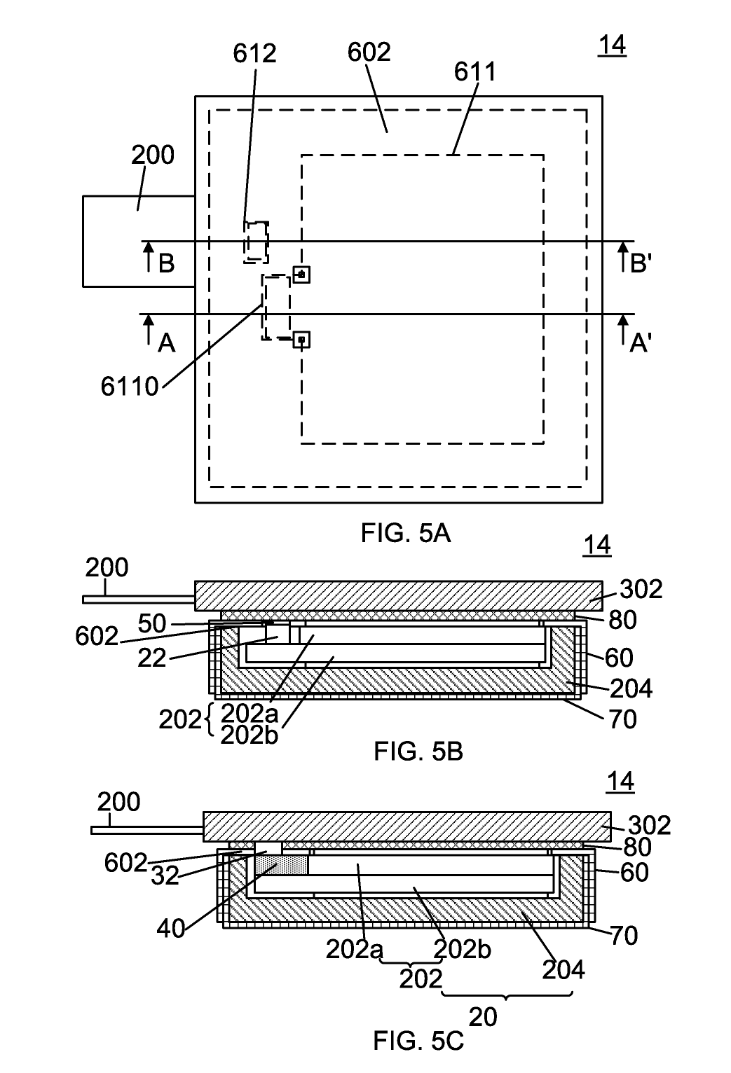

Please refer to FIGS. 5A-5C. FIG. 5A illustrates a top view of a touch display device 14 according to a fifth embodiment of the present invention. FIG. 5B illustrates a section A-A′ view of the touch display device 14 in FIG. 5A. FIG. 5C illustrates a section B-B′ view of the touch display device 14 in FIG. 5A. In the present embodiment, the display module 20, the touch panel 30, the control chip 22, and the driving chip 32 have the same functions and connections as those in the second embodiment of FIGS. 2A-2B, and thus are not repeated herein. In the present embodiment, the thickness of the control chip 22 is greater than the thickness of the top substrate member 202a of the display panel 202, and the thickness of the driving chip 32 is greater than the thickness of the adhesion layer 80.

As shown in FIG. 5A, the first frame 60 does not shelter the display area of the display module 20, the control chip 22, and the driving chip 32. The top frame member 602 defines not only the indentation 6110 but also the opening 612 for exposing the driving chip 32.

As mentioned above, the differences between the touch display device 14 of the present embodiment and the above-mentioned embodiments are that the thickness of the control chip 22 is greater than the thickness of the top substrate member 202a of the display panel 202 as shown in FIG. 5B (i.e. the control chip 22 protrudes the display panel 202), and the thickness of the driving chip 32 is greater than the thickness of the adhesion layer 80 as shown in FIG. 5C. The top frame member 602 of the first frame 60 which is disposed between the display module 20 and the touch panel 30 only shelters the edge areas of both the display module 20 and the touch panel 30, and the top frame member 602 exposes the display area of the display panel 202, the control chip 22 (as shown in FIG. 5B), and the driving chip 32 (as shown in FIG. 5C). Accordingly, although the thickness of the driving chip 32 is greater than the thickness of the adhesion layer 80, the driving chip 32 does not directly contact the top frame member 602 of the first frame 60 which is disposed between the display module 20 and the touch panel 30. As well, although the thickness of the control chip 22 is greater than the thickness of top substrate member 202a of the display panel 202 so as to protrude the display panel 202, the control chip 22 does not directly contact the top frame member 602 of the first frame 60 which is disposed between the display module 20 and the touch panel 30 so as to retain the structural integrity of the touch display device 14.

In the present embodiment, the insulating tape 50 is formed on the control chip 22, and the insulating tape 50 is fixed on the adhesion layer 80. Furthermore, as shown in FIG. 5C, the buffer layer 40, such as a sponge layer or an elastic insulating material layer, can be selectively disposed between the exposed surface of the driving chip 32 and the display module 20, so as to increase the structural strength of the touch display device 14.

In the present embodiment, the display module 20 is contained in the second frame 70 as the same as the above-mentioned embodiments. As a result, the display module 20 can be fixed by the first frame 60 together with the second frame 70.

The touch display devices 10, 11, 12, 13, and 14 according to the aforementioned embodiments can be applied to one electronic apparatus. The electronic apparatus comprises a power supply which is electrically coupled to one of the touch display devices 10, 11, 12, 13, and 14 for providing power. The electronic apparatus, which comprises the touch display device, can be a mobile phone, a digital camera, a Personal Digital Assistant (PDA), a notebook, a desktop computer, a television, a Global Positioning System (GPS), a vehicle display, an aeronautical display, or a portable digital video disc (DVD) player.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A touch display device, comprising:
a display module comprising a display panel and a first chip disposed at the display panel; and
a touch panel disposed on the display module, the touch panel comprising a substrate and a second chip, which is disposed on the substrate and misaligned with the first chip of the display module.

2. The touch display device as claimed in claim 1, wherein the display panel is a liquid crystal panel.

3. The touch display device as claimed in claim 1, wherein the display module further comprises a backlight module, and the display panel is disposed on the backlight module.

4. The touch display device as claimed in claim 1, further comprising an adhesion layer disposed on peripheral edges of one surface of the touch panel, on which the second chip is disposed, for assembling the touch panel and the display module.

5. The touch display device as claimed in claim 1, further comprising an adhesion layer disposed on an entire surface of the touch panel, on which the second chip is disposed, for assembling the touch panel and the display module.

6. The touch display device as claimed in claim 1, wherein an insulating tape is adhered to one surface of at least one of the first chip and the second chip.

7. The touch display device as claimed in claim 1, further comprising a first frame having a top frame member and an edge frame member, the top frame member disposed between edge areas of the display module and the touch panel, and the edge frame member surrounding side edges of the display module.

8. The touch display device as claimed in claim 7, wherein the top frame member of the first frame shelters both the first chip and the second chip.

9. The touch display device as claimed in claim 7, wherein the top frame member of the first frame shelters the first chip and exposes the second chip.

10. The touch display device as claimed in claim 7, wherein the top frame member of the first frame shelters the second chip and exposes the first chip.

11. The touch display device as claimed in claim 7, wherein the top frame member of the first frame exposes both the first chip and the second chip.

12. The touch display device as claimed in claim 7, further comprising a buffer layer disposed between the display module and the second chip.

13. The touch display device as claimed in claim 7, further comprising a buffer layer disposed between the display module and the top frame member of the first frame.

14. The touch display device as claimed in claim 1, wherein the first chip is a control chip for controlling the display module.

15. The touch display device as claimed in claim 1, wherein the second chip is a driving chip for controlling at least one touching operation for the touch panel.

16. The touch display device as claimed in claim 1, wherein the substrate is a glass substrate, and the second chip is disposed on the glass substrate through a chip-on-glass (COG) process.

17. The touch display device as claimed in claim 1, further comprising a second frame for containing the display module.

18. An electronic apparatus, comprising:
a touch display device as claimed in claim 1; and
a power supply electrically coupled to the touch display device for providing power to the touch display device,
wherein the electronic apparatus is a mobile phone, a digital camera, a Personal Digital Assistant (PDA), a notebook, a desktop computer, a television, a Global Positioning System (GPS), a vehicle display, an aeronautical display, or a portable DVD player.
